(19) United States
(12) Patent Application Publication
(10) Pub. No.: US 2010/0264279 A1
(43) Pub. Date: Oct. 21, 2010

(54) Cable organizer, storage and porting utility

(76) Inventor: Don Allen, Loomis, CA (US)

Correspondence Address: Walt Froloff, 273D Searidge Rd, Aptos, CA, 95003, US

(21) Appl. No.: 12/386,699

(22) Filed: Apr. 21, 2009

(51) Int. Cl. F16L 3/22; A44B 18/00

(52) U.S. Cl. 248/68.1; 24/447

(57) ABSTRACT

The cable caddie is an apparatus for organizing, storing and porting cables and is made from a durable flexible fiber strap piece between 3 and 6 feet long forming the base layer, a terminal or handle coupled to at least one end of the strap, and at least one Velcro strip piece with one end of the strip piece coupled on to the flexible strap base layer and the distal end having the mating Velcro fiber forming a loop when mated when the distal end is folded upon the coupled end. Wrapped or wound cable are held in the Velcro strip loop formed when the strip is folded over the wrapped cable loops and onto the mating Velcro side securing the cable loop to the base layer. Several such Velcro strips for easy looping about and securing the cables to the base strap carrier, can provide organization and allow easy porting of many cables, as the base strap can be rolled up and carried by the handles attached.

### BACKGROUND

1. Field of the Invention

The present invention generally relates to storage, organizing and porting utilities and more specifically, for flexible cable and cord organization, storage and porting.

The general area of organizers and storage utilities is not new. Cables are heavy and somewhat flexible. Cords and cables can get easily disorganized and entangled. The task of untangling a specific cable from a bunch, can be unwieldy, costly and a frustrating exercise. Cable or cords my become tied in knots, further exacerbating the challenge of obtaining just the cable or cord selected.

Organizing devices have been proposed. One such consists of straps and buckles. The strap loop may even sport a removable cinch strap for coupling with the buckles for tightening and adjustment.

But buckles and cinches are made from hard materials. Hard material may damage the sensitive cable, attached and expensive microphones or cords by unintended pressing or smashing against them. Then there is the additional cost to manufacturing buckles which must be considered. Securing cables and cords for organization, storage and porting is needed without the added expense of buckle manufacturing or potential damage from hard buckles.

Suspended garment and/or shoe bags mounted to extendable or telescoping support members which are mounted to a clothing rod in a closet by a hanger bar have been disclosed. These can be carried by the telescoping member so as to be extendable generally perpendicularly with respect to the elongated axis of the clothing rod so that the garment and/or shoe bags are selectively displayed in an area spaced outwardly of any other articles of clothing which may be suspended from the clothing rod.

While these types of apparatus for suspending articles of clothing from a clothes rod in a closet, are used as an organizing means, the organization is pocket based, so articles exceeding the pocket size or articles which vary in size will not fit in this apparatus. There is the problem of wasted space where the pocket volumes are not filled. What is needed are storage and tot devices which can handle extendable cable or cord length loops to allow for all various sizes of loops, without limitation of pocket size.

Other cord organizers have been disclosed. One such is has an elongate cylindrical body member with a longitudinal interior passageway formed there through for receiving folded, bundled cords such as electrical power cords and other wiring. The interior diameter of the passageway decreases gradually and smoothly radial inwardly from the opposite outer ends of the passageway toward its center. The folded cord is retained in the interior passageway through the body. The organizer may be used with cords that are in use with appliances and the like to keep the cords organized and out of the way.

Some of these apparatus only work for one or two cords and therefore are not useful for multiple cords. Some are configured for cords and not cables, as they require a bending that would stretch, snap or otherwise damage a cable. What are needed are organizers and porter devices that can handle all of these items and more.

Another cable organizer comprises a centerpiece, a first loop portion, and a second loop portion. The first loop portion defines a first bore adapted to receive at least one cable. It also includes a first end that abuts a first side of the centerpiece to close the first bore. This first end is deflectable for radial insertion of the at least one cable winding within the first bore. The second loop portion defines a second bore for at least one cable winding. The second loop portion includes a second end that abuts a second side of the centerpiece to close the second bore. This second end is also deflectable for radial insertion of the at least one cable winding within the bore. The first and second sides of the centerpiece oppose each other. The centerpiece prevents tensional opening of the first and second bores.

While usable for two cables, this rigid centerpiece organizer does not organize as many cables as the typical cable user may want or need. This organizer is not amenable for bulk storage, as 2 cords stored together may still be as disorganized as single cables, thrown into a storage or porting space. Some parts of these organizers are manufactured from rigid but flexing material. Your What are needed are reduced cost organizers, without plastic buckles to manufacture and affix, organization and deployment ease and increases the ease of use, through simple cheap and readily available components giving loop adhesion.

### SUMMARY

The present invention discloses an apparatus for organizing, storing and porting cables. This apparatus called a cable caddie is made from a durable flexible fiber strap piece between 3 and 6 feet long forming the base layer, a terminal or handle coupled to at least one end of the strap, and at least one Velcro strip piece with one end of the strip piece coupled on to the flexible strap base layer and the distal end having the mating Velcro fiber forming a loop when mated when the distal end is folded upon the coupled end. Wrapped or wound cable are held in the Velcro strip loop formed when the strip is folded over the wrapped cable loops and onto the mating Velcro side securing the cable loop to the base layer. Several such Velcro strips for easy looping about and securing the cables to the base strap carrier, can provide organization and allow easy porting of many cables. The Cable caddie base strap is made of strong flexible fiber from of materials such as nylon webbing, webbing, flat nylon, patterned webbing, polyester, poly propylene, flex tubing and tubular nylon.

Although extremely simple and elegant, the cable caddie adds versatility by accessories such as a hook with a back plate coupled to the base layer strap by the Velcro strip. Versatility can be increased through the use of multiple cable caddies in parallel, positioned or hung in parallel with rods or bars supported by the Velcro loops at the ends for hanging many other items in groups for easy and simple assembly, display, disassembly and portability.

### BRIEF DESCRIPTION OF DRAWINGS

Specific embodiments of the invention will be described in detail with reference to the following figures.

FIG. 1 illustrates a front and side view of a cable caddie in accordance with an embodiment of the invention.

FIG. 2 shows a front and side view of a cable caddie with porting handles in accordance with an embodiment of the invention.

FIG. 3 shows a front and side view of a cable caddie with hook accessories in accordance with an embodiment of the invention.

FIG. 4 shows a front and side view of a cable caddie with extensible rod hanging accessory in accordance with an embodiment of the invention.

### DETAILED DESCRIPTION

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Objects and Advantages

The present invention discloses a utility for organizing, storing and porting cables and cords.

Accordingly, it is an object of the present invention to provide a more efficient and less material expensive solution to the cord/cable organizing.

It is another object of the present invention to provide embodiments designed for a less expensive material process for manufacturing embodiments of the invention.

It is another object of the present invention to provide embodiments designed for a less expensive process for manufacturing the invention

It is another object of the present invention to provide embodiments designed for easy and safe from crimping or damage from storage or porting of cable and attached accessories such as microphones, holders, plugs and or cords.

It is another object of the present invention to provide a cable organizing, storage and porting utility which is itself collapsible into a small package when not in use.

### Embodiments of the Invention

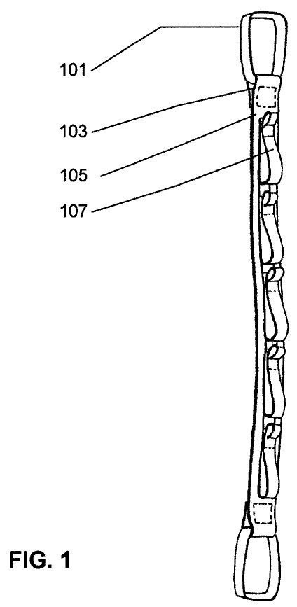

FIG. 1 illustrates a front and side view of a cable caddie in accordance with an embodiment of the invention. This embodiment shows a apparatus for organizing storing and porting cables having a durable flexible fiber strap webbing forming the base layer 105, a strap end with a flexible loop terminal or semi-flexible handle 101 is coupled to the end of the base webbing strap by through a simple loop 103 around the terminal, sewn, glued or otherwise coupled back onto the strap. The base 105 can be made from nylon, webbing, flat nylon, patterned webbing, polyester, poly propylene, flex tubing, tubular nylon and the such materials. Velcro strip pieces 107 with one portion of the strip piece coupled on to the flexible strap, are folded onto themselves with the mating Velcro side disposed to attach the folded base attached strip 107 portion. Other looping materials can be used. Thus a wound-up cable. will be held in the Velcro strip loop formed when the strip is folded over the wrapped cable loops and onto the mating Velcro side securing the wrapped cable to the base layer. Not shown are the color schemes that can be employed to further organize items on the caddie. Different color loop strips 107 or different position strip can be used for this function.

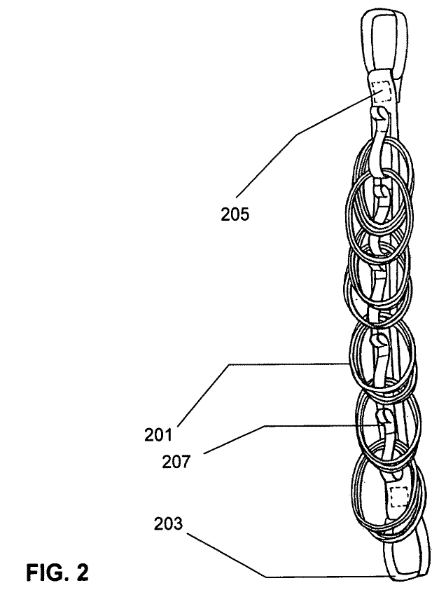

FIG. 2 shows a front and side view of a cable caddie with porting handles 203 in accordance with an embodiment of the invention. The flexible fiber base 205 can be made of nylon webbing, other synthetic material, leather or other tough and light weight material. The terminal or handle(s) 203 are thin flexible material, strong enough to port a rolled up base 203 with the weight of multiple wrapped cables 201. The handles can be of plastic, synthetic fiber, or strong natural fiber material sewn or otherwise coupled to the flexible fiber base 205 strap. Velcro strips 207 are sown, glued, stapled or otherwise coupled to the base 205 so that a loop can be formed by folding the strip around a cable or other article for porting or storage purposes. An embodiment of the invention can be hung by the handle 203 vertically such that articles can be readily visible even in tight well packed storage and accessed from display or storage quickly and easily

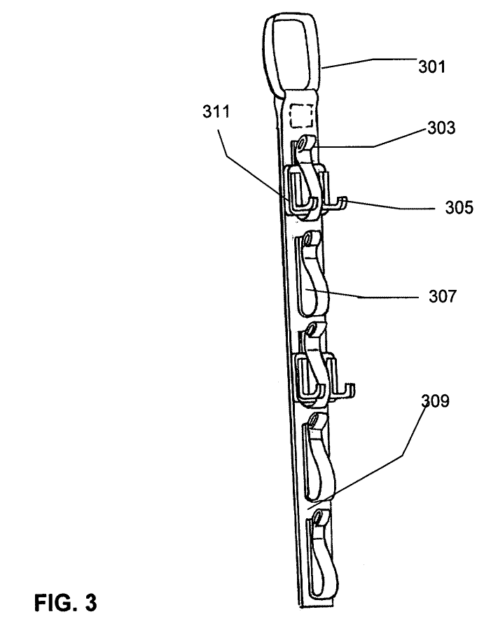

FIG. 3 shows a front and side view of a cable caddie with hook accessories in accordance with an embodiment of the invention. The handle 301 is coupled to a flexible base layer strap 309 which hung from a point providing a vertical extension of the caddie for placement of various articles. Dual hook 311 construction on a back plate 303 are coupled to the base layer 309 such that necklaces, belts, scarves, hats, Christmas lights, sports equipment, outdoor equipment, tubing, clothing, tools and other various article can be hung from the hooks 311 or Velcro looped strips coupled to the base layer strap 309. A hook 311 can also be coupled to the base strap 309 by Velcro strips 307 in loop fashion over the hook 311 middle back plate 303. Thus small or long unwieldy articles can be neatly folded or bundled and stored or hung on display quickly and easily. This also provides a storage mechanism or display prop, to find an article quickly and easily by inspection.

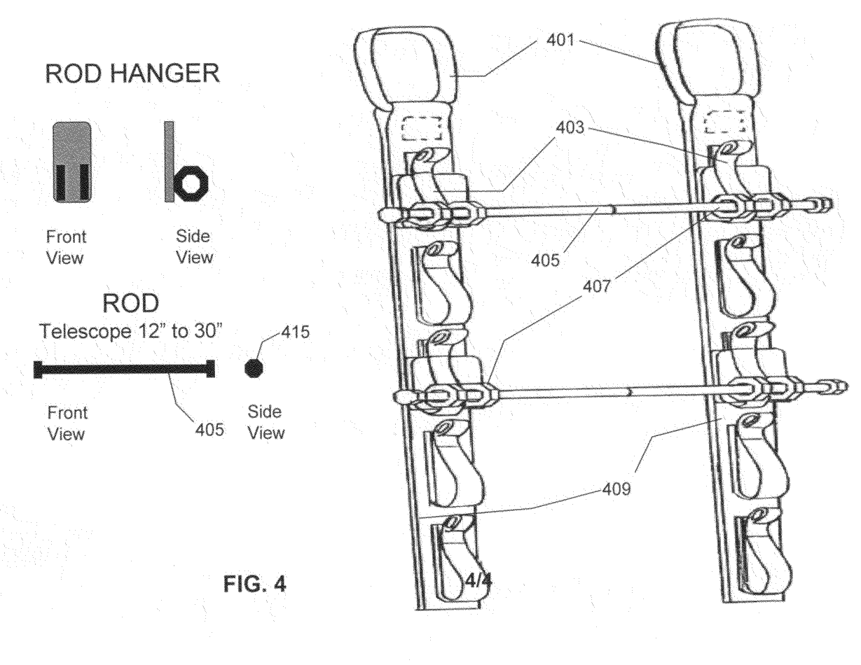

FIG. 4 shows a front and side view of a cable caddie with extensible rod 405 for hanging various items an accessories in accordance with an embodiment of the invention, between a set of caddies. A pair of the cable caddie embodiments hung vertically can be used in parallel, hung by the end handles 401 to support a horizontal bar 405 or rod which can themselves be used to support or organize various articles for display or storage. The bar or rod 405 can be extensible for quick and easy storage, transport and setup. The bar 405 slides through a double hole attachment 407 accessory which can be made from plastic, composite, metal, wood or other materials. The hole attachment 407 accessory is coupled to a back plate 409. A Velcro strap loop 403 can also suffice to support a horizontal cross bar 405 in lieu of a hole attachment accessory.

The bar can support various items such as jewelry, towels, spools, pants, ribbon, yarn, string and others. An advantage and aspect of the invention is to provide a quick setup for organization and display of many various kinds of items as well as a quick re-packing for portability and or storage. Simple roll up packing and unpacking, easy portability and storage in various dimension storage spaces.

Therefore, while the invention has been described with respect to a limited number of embodiments, those skilled in the art, having benefit of this invention, will appreciate that other embodiments can be devised which do not depart from the scope of the invention as disclosed herein. Other aspects of the invention will be apparent from the following description and the appended claims.

What is claimed is:

1. An apparatus for organizing, storing and porting cables comprising:
a durable flexible fiber strap piece between 3 and 6 feet long forming the base layer,
a terminal or handle coupled to at least one end of the strap, and
at least one Velcro strip piece with one end of the strip piece coupled on to the flexible strap base layer and the distal end having the mating Velcro fiber forming a loop when mated when the distal end is folded upon the coupled end,
whereby a wrapped cable will be held in the Velcro strip loop formed when the strip is folded over the wrapped cable loops and onto the mating Velcro side securing the cable loop to the base layer.

2. The apparatus for organizing storing and porting cables as in claim 1 wherein the flexible fiber forming the base layer is of material from the group of materials containing nylon webbing, webbing, flat nylon, patterned webbing, polyester, poly propylene, flex tubing and tubular nylon.

3. The apparatus for organizing storing and porting cables as in claim 1 wherein the terminal or handles are made of material from a group of materials consisting of thin flexible material, plastic, synthetic fiber and strong natural fiber material.

4. The apparatus for organizing storing and porting cables as in claim 1 further comprising a hook with a back plate accessory which is coupled to the base layer strap by the Velcro strip.

5. The apparatus for organizing storing and porting cables as in claim 1 further comprising the use of more than one apparatus positioned or hung in parallel with rods or bars supported by the Velcro loops at the rod ends.

6. The apparatus for organizing storing and porting cables as in claim 5 further comprising extendable rod or bar.
